(19) United States
(12) Patent Application Publication
(10) Pub. No.: US 2011/0259264 A1
(43) Pub. Date: Oct. 27, 2011

(54) DEVICE FOR THE APPLICATION OF FLUID COATS TO SURFACES

(76) Inventor: Diego Cervera, Cdad. Aut. de Buenos Aires (AR)

(21) Appl. No.: 13/093,938

(22) Filed: Apr. 26, 2011

(30) Foreign Application Priority Data
Apr. 27, 2010 (AR) 20100101415

(51) Int. Cl. B05C 1/00; B05C 11/10; B05C 11/11; B05C 11/00

(52) U.S. Cl. 118/255

(57) ABSTRACT

Device for the application of fluid coats to surfaces. The device includes a main body (1) through whose back part closed (1b) and by means of a movable connection (2a) with a brake (20), connects to a command grip (2) that allows several angular positions for the main body (1). It has a set of rollers (3) that, rotationally mounted on the lateral walls (1c) of said main body (1) and bulging out by the open front part (1 a) of same (1), are fed with the fluid supplied by a distribution device (5) that is connected to a feeding circuit (4) and whose supply comes from an auxiliary feeding device (40) that may be regulated by an operation means (4b).

### FIELD OF THE INVENTION

This invention refers to the field of the different industrial techniques, and, among them, to the devices for the application of fluids or other fluid materials to surfaces in general.

Specifically, it consists of a device for the application of fluid coats to surfaces, which has been prepared for working in surfaces in any position and with a uniform distribution of the fluid. This uniform distribution is achieved through a set of rollers fed by a distributing device, a feeding circuit and an appropriate movable connection.

### PRIOR ART

There are different kinds of devices for the application of fluid contents to surfaces know at present.

The most traditional manual ways consist in the use of rollers and/or brushes that cause problems as fundamental as basic. Some of those problems usually lie in the need of big physical efforts; the need for constant reloads of fluid due to the reduced surface covered by a single load, the stains in clothing and other surfaces due to the unavoidable transfer of the brush or roller from the deposit with the fluid to the surface of application, uncontrollable spills caused by the interaction between the element that applies the fluid and the surface receiving same, the waste of fluids (as in the case of paint or varnish) that occurs when they dry in the containers exposed to the air, etc.

An option to the most traditional systems are the semi-automatic rollers that store the fluid to apply inside of them. In general, these devices present big and varied inconveniences such as inappropriate material components caused by flat rollers that cannot be used in irregular surfaces, an excessive weight—due to the addition of the device's and the fluid's weighs—that makes it difficult to maneuver the device during long periods of time, total or partial obstructions in the outlet pipes due to the fact that the remaining fluid inside the rollers dries, the short useful life of the rollers, which, after few times using them start obstructing the free passage of the fluid, the low autonomy, that requires constant reloading of the device, the uneven distribution of the fluid on the surface due to the constant flow that cannot be regulated, etc.

An alternative to the above-mentioned devices are the electrical rollers that have small outlet orifices on their surfaces and are fed by a pipe connected to a feeding pump.

Among some of the inconveniences caused by the electrical rollers are the large amount of time that has to be wasted in the complicated cleaning of its numerous parts, the waste of time in the mandatory purging of the feeding system after each use, the obstructions caused by the presence of dry fluid in the outlet pipes and, as unavoidable consequence, the reduced short useful life of the roller, that ends up acting as an obstruction element.

There are lots of devices that have, or even alternate, the above-mentioned deficiencies. For instance, the patent document AR234599 consists of a device that does not have means to distribute the fluid uniformly in the entire surface of the rollers for further application of same on the surface in a correct way. It has to be noted that, since the fluid deposit is integrated to the main body, it becomes difficult to maneuver due to the addition of the device's and the fluid load's weights. On the other hand, the limited positional regulation device between the handle and the rollers only permits two angular positions.

The patent document AR032092A4 discloses an iron stick that, on one of its ends has a handle, and on the opposite one a U shape used to receive and work as the axis of two rollers. This invention has inconveniences such as a main body limited to the use of two rollers, a single structure that does not allow a varied angular positioning of the handle with respect to the rollers, total lack of means for feeding and regulating the passage of fluid and no structure for containing the rollers or the excess of fluid.

The patent document AR009711A1 shows a device where the fluid deposit is integrated to the handle's and the roller's structure. This integration brings as consequence a very heavy device, difficult to maneuver, and a reduced length that only allows the application of fluids at the short reach of the hand. In addition, the structure's rigidity does not facilitate a comfortable application of the fluid on surfaces at varied angular positions.

The patent document AR025565A1 shows a device with rollers mounted on an only horizontal axis and has an internal loading system for each roller. The lack of articulation or movement between the axis and the rollers make of this invention a rigid device which is not appropriate for any angular surface. In addition, since the fluid is within the rollers, the already mentioned problems such as the short useful life of the rollers that end up obstructing the passage of the fluid and the increased total weight of the device and further inconveniences in the manipulation also occur.

The patent document AR021418A1 discloses a simple structure that includes at least one roller and has no feeding, regulation or distribution means, and no manual means for angular positioning.

The patent document AR009530A1 shows a device which may be used specifically to mark the edges of metallic or similar nettings.

The patent document AR040954A4 discloses a device to paint surfaces in an angle by means of two rollers that, united in one of their ends, are at 90° angle. These rollers are fixed to a support with a plastic handle through an intermediate plastic piece that allows the movement and rotation of the rollers and the support with handle. This device does not have feeding and distribution means, a means for containing the excess of fluid of the rollers or a minimum support structure to avoid stains on undesired surfaces during the load of fluids or during its use on surfaces. Besides, the lack of feeding means of this device requires the unavoidable use of a separate fluid container.

### SUMMARY OF THE INVENTION

The objective of this invention is to supply a device to resolve the basic and elemental needs and to correct the fundamental errors observed in the vast majority of devices known as of this moment.

An advantage of this device is that its main body avoids the stains on undesired surfaces that usually occur either due to the excess of fluid on the roller or due to the drops that fall when the rollers are in contact with the surface.

Another advantage lies in that thanks to its simple structure and to the fact that its pressurization tank does not become stained, the estimated washing time is reduced to a large extent.

Another advantage is that with an only coat of fluid it is possible to obtain the same results as with two coats with an ordinary roller.

Another advantage is that the device for the distribution of fluid allows a uniform distribution of same on the roller's surface, and therefore a uniform distribution of the fluid on the surface on which it is applied.

Another advantage is that, since the fluid distribution device is independent from the rollers, they never obstruct the passage of fluid or difficult the cleaning of the supplying openings.

Another advantage that may be observed is that since it operates with an ordinary roller, its useful life depends on the roller chosen and not on the specific features of the device.

Another advantage is that thanks to its feeding method that avoids constant loading of fluid, it allows an easier, fast and comfortable work.

Another advantage is that thanks to its anti-drying cap, works may continue uninterruptedly for long periods of time keeping the rollers wet and without the urgent need of having to wash them.

Another advantage is that its auxiliary fluid-feeding device is independent from the main body and this brings as consequence a lighter body which is easier to manipulate.

Another advantage is that thanks to the auxiliary fluid-feeding device, its feeding circuit and its distributing device, there is practically no waste of fluid caused by drying or due to the constant exposure to the air.

### DESCRIPTION OF THE DRAWINGS

For further clarification and understanding of this invention's object, it has been illustrated with several figures in which it has been represented in the preferred performance ways for illustrative purposes, but not limited to that:

FIG. 1 is a cross-sectional view of this device that shows its constitution as well as its main parts;

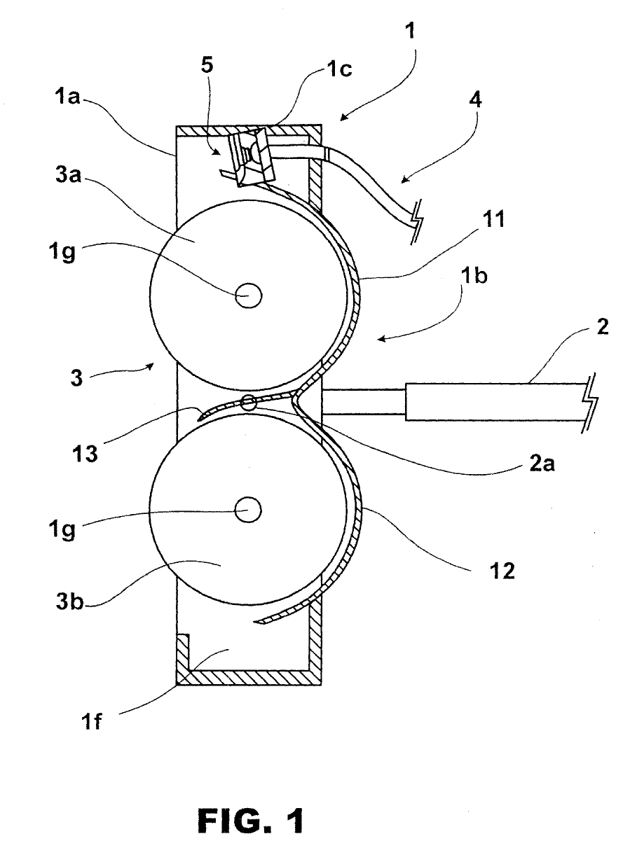

FIG. 2 is a cross-sectional view of the main body in horizontal position that shows its main components in detail. It may also be observed how the excess of fluid falls into the cap's cavities, where it may be taken by the roller with which is in contact.

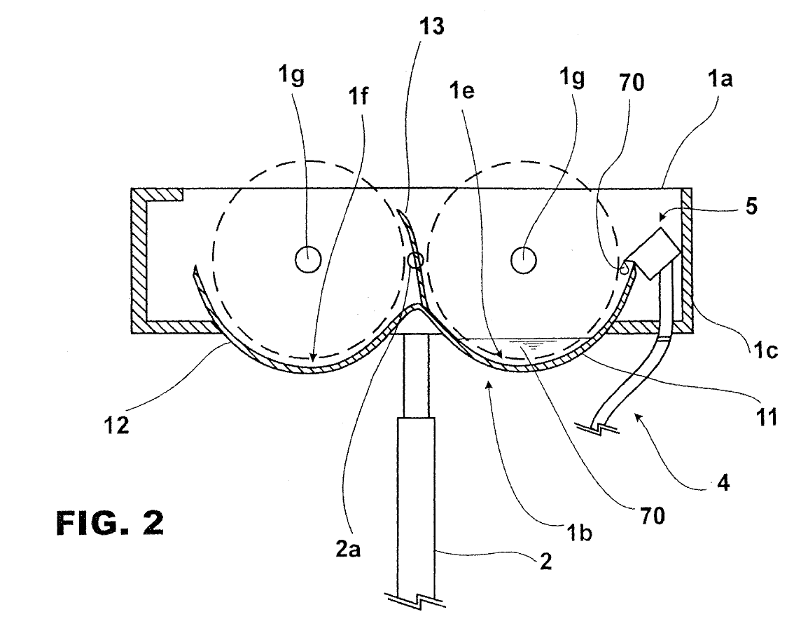

FIG. 3 is a perspective view of this device's back part in a form of performance with gear brakes.

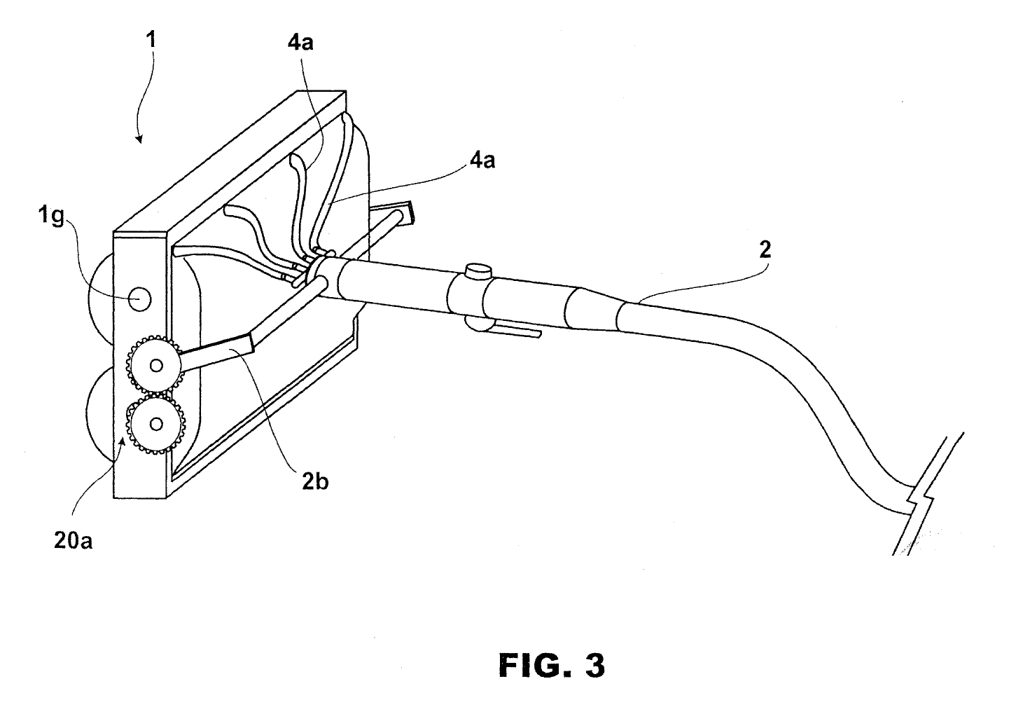

FIG. 4 is a perspective view of the back part of this device in a form of performance with elastic brake.

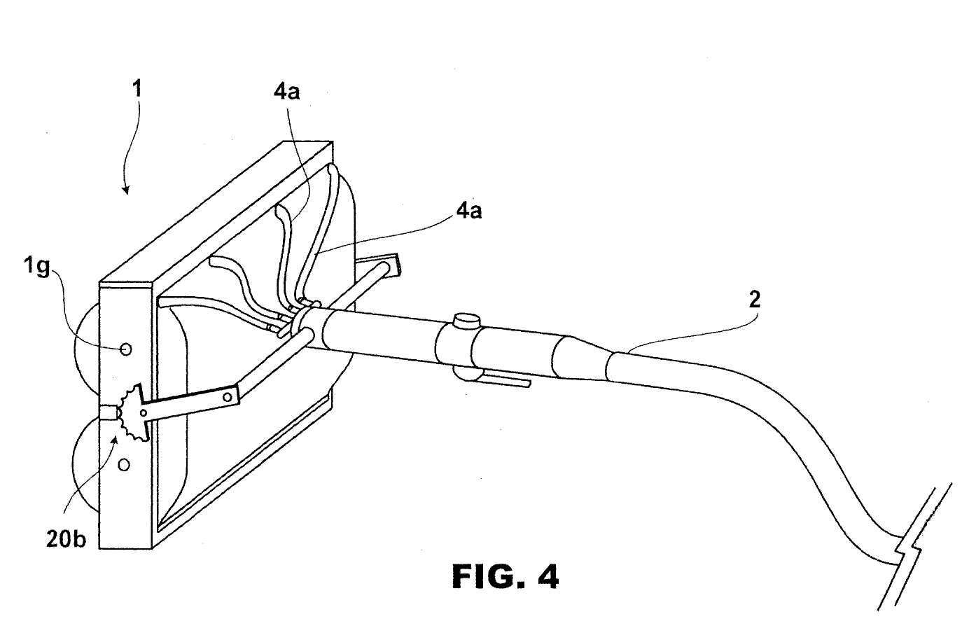

FIG. 5 comprises Figures A and B, as follows: Drawing A is a perspective view of this device's back part, in a form of performance with friction brakes. Drawing B is a detail front view, raised, of drawing's A movable connection.

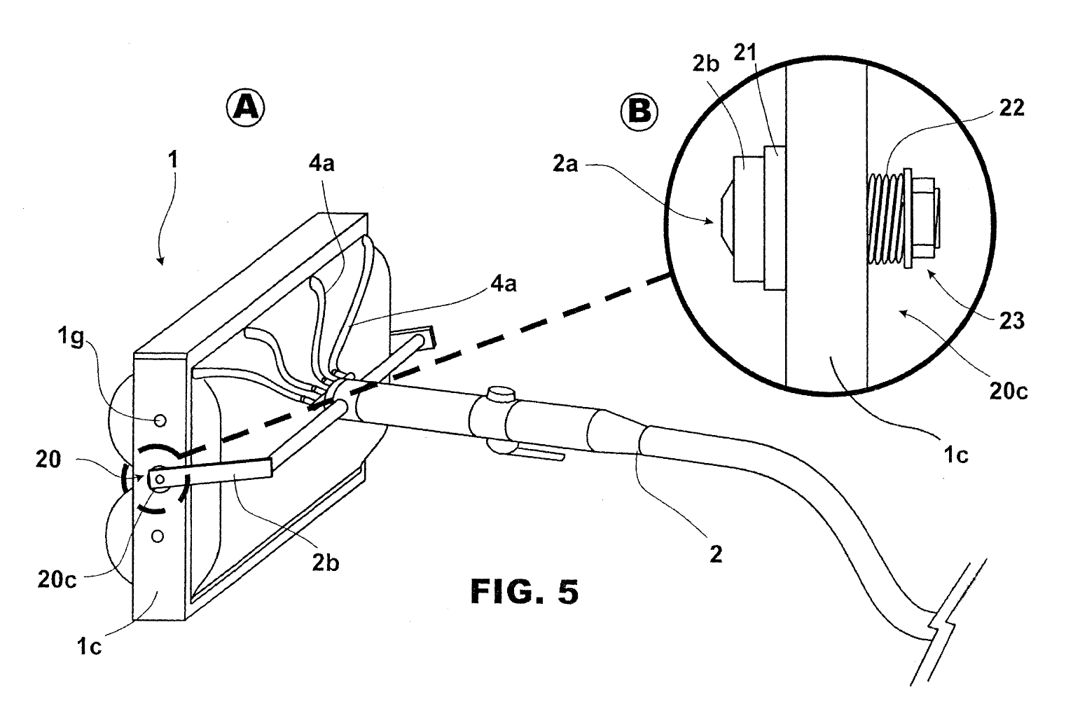

FIG. 6 is a detail view with crosscut of the elastic brake, where the different components may be observed.

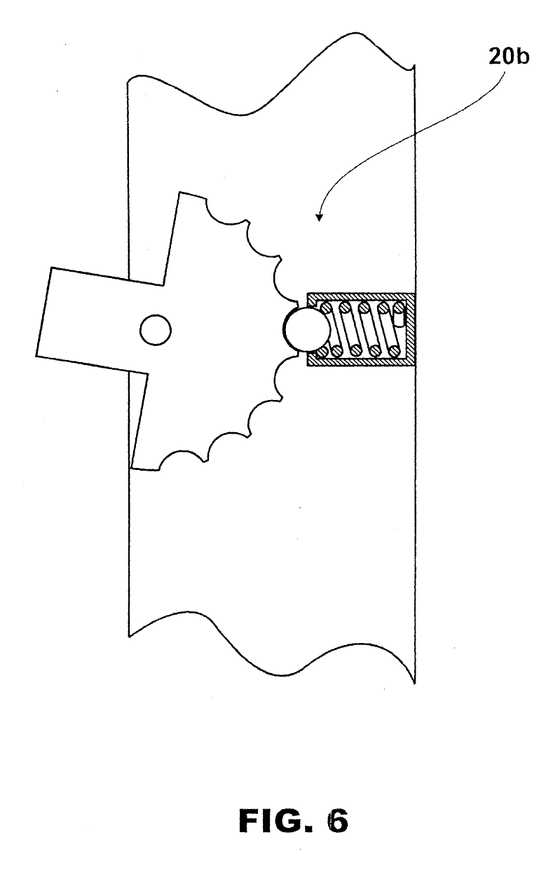

FIG. 7 is a perspective view showing the relative position of the distribution device and the set of rollers.

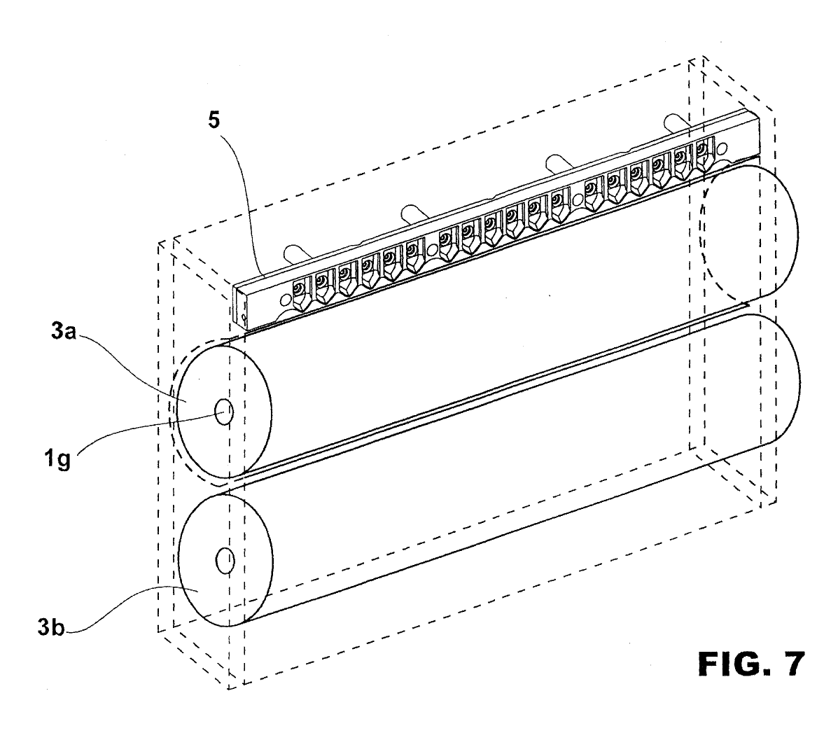

FIG. 8 is a view in perspective of the distribution device's front part.

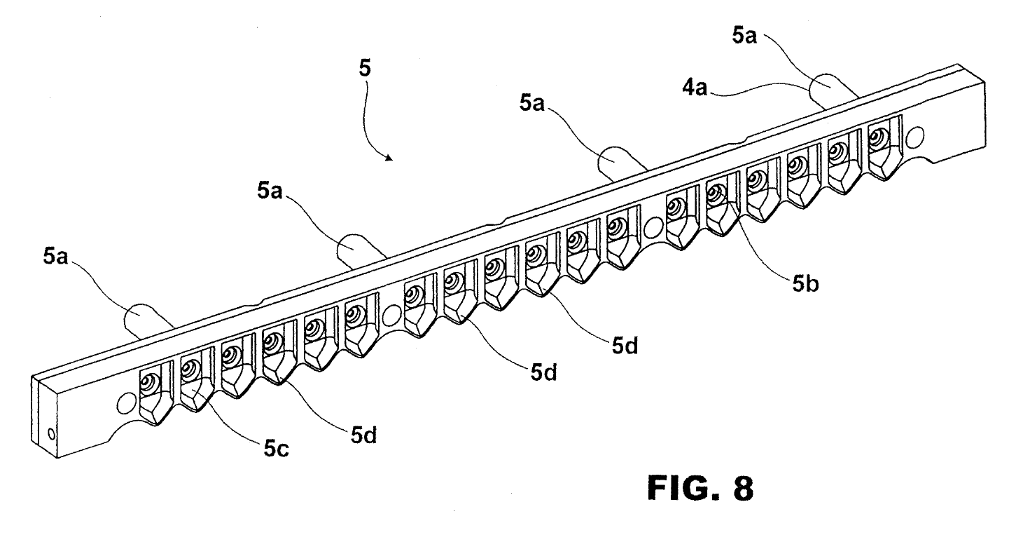

FIG. 9 comprises the Figures A, B and C, as follows: Drawing A is a detail of a view in perspective of the distribution device's front part; Drawing B is a detail of a view of the distribution device's low part. Drawing C is a detail of a view in perspective of the distribution device's back part.

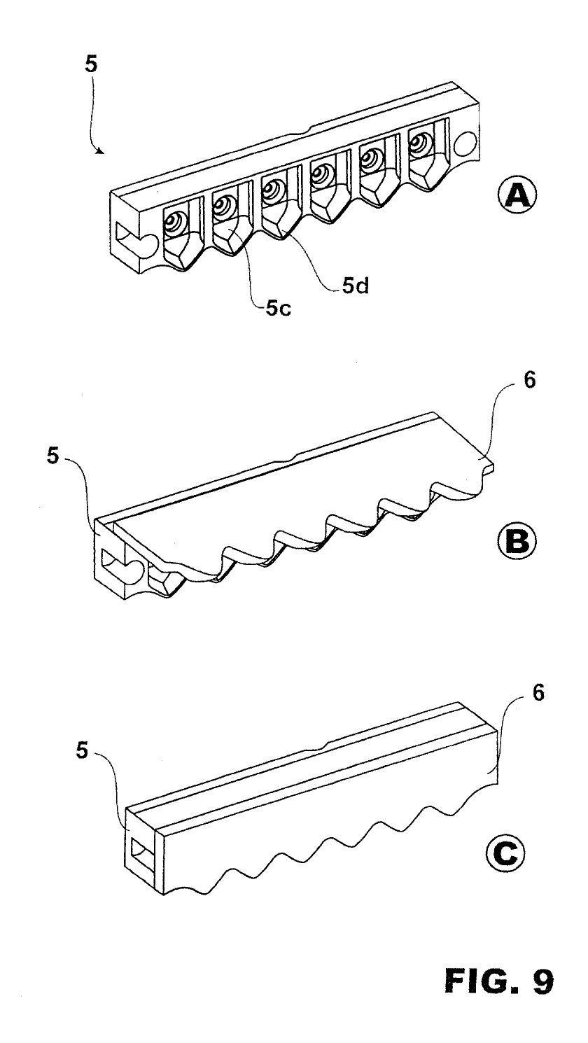

FIG. 10 comprises the drawings A, B, C and D, in which: Drawing A is a front view, raised, of the distribution device; Drawing B is a crosscut of said distribution device, as per the X-X shear plane. Drawing C is a longitudinal section of said distribution device, as per the Y-Y shear plane, and Drawing D is an upper view, raised, of said distribution device.

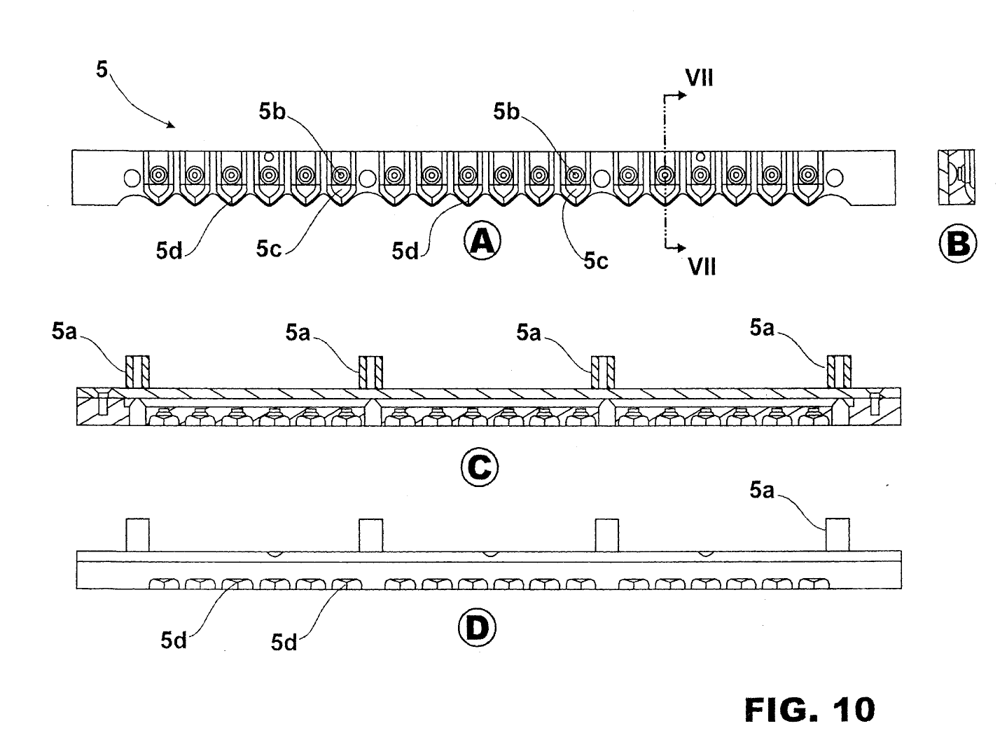

FIG. 11 is a perspective view showing the device connected to an auxiliary feeding device.

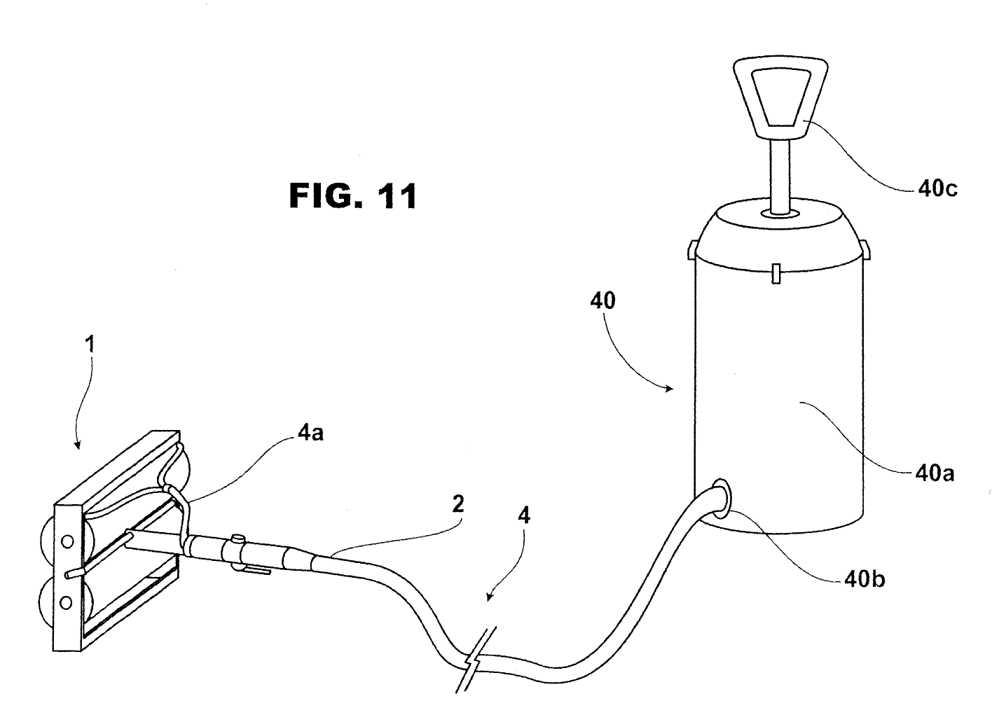

FIG. 12 is perspective view showing this device's use on a vertical surface.

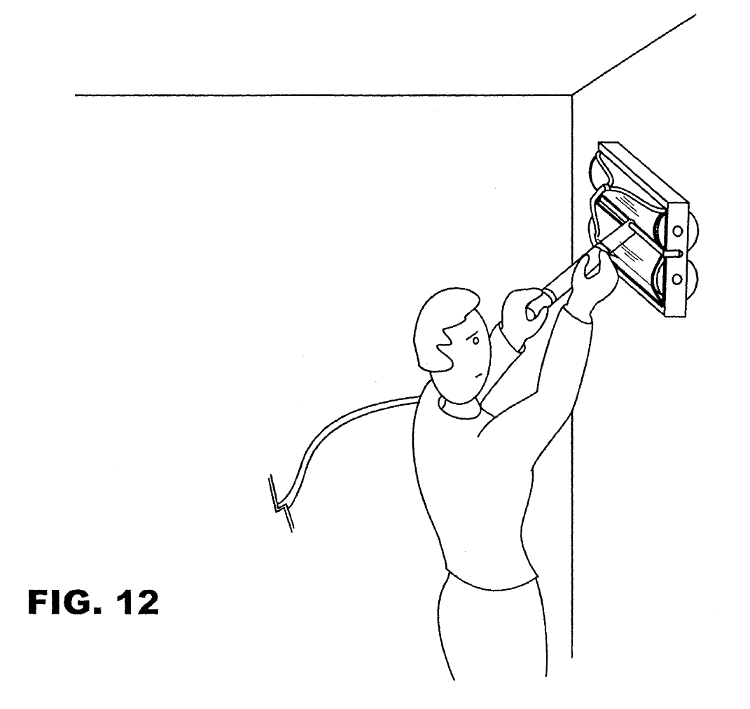

FIG. 13 is a perspective view showing this device's use on a raised horizontal surface.

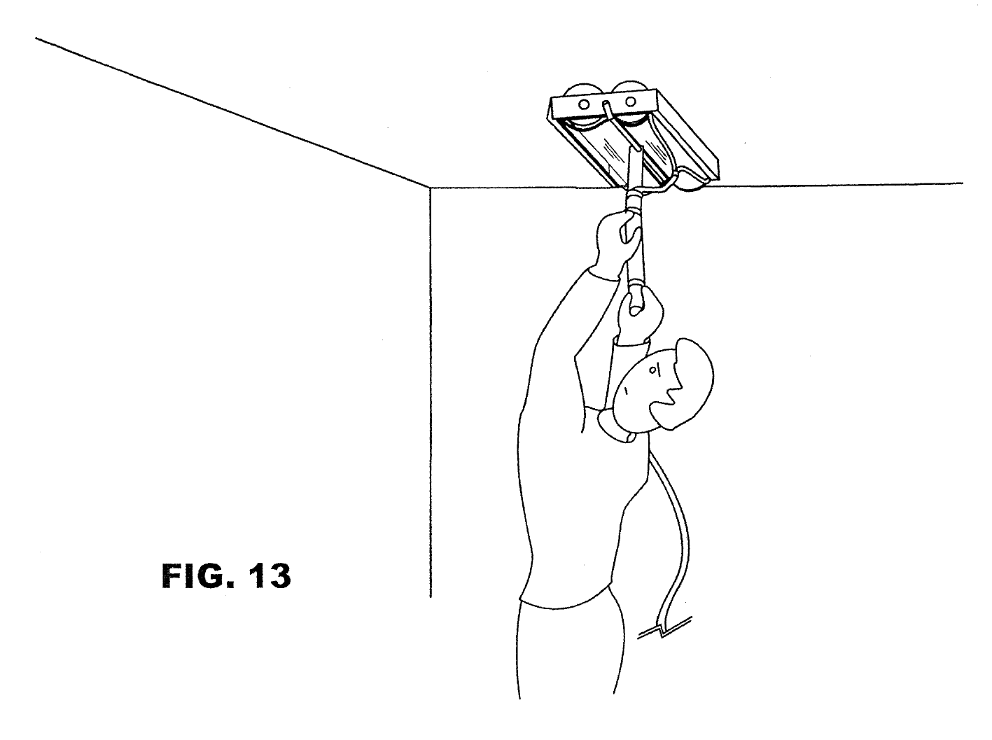

FIG. 14 is a perspective view showing an auxiliary feeding device with its cap opened that allows observing its components.

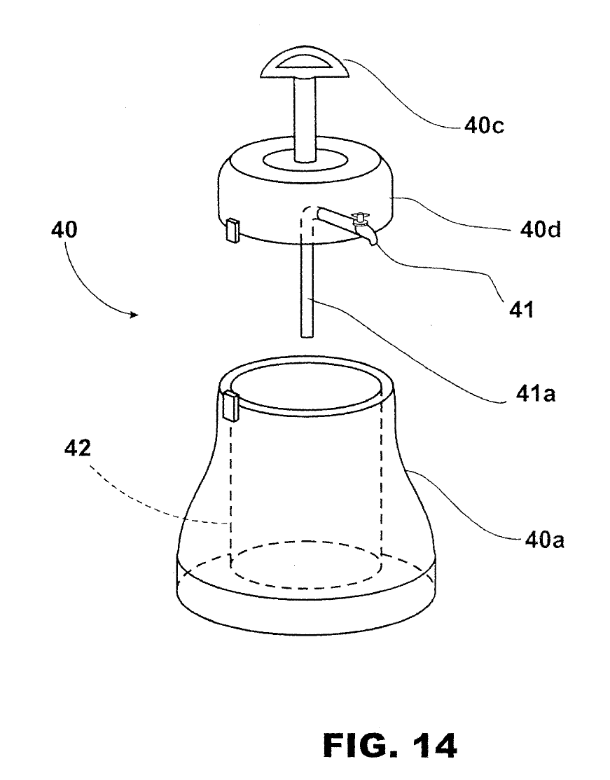

FIG. 15 are two lateral views, raised, that show the device with its frontal anti-drying cap.

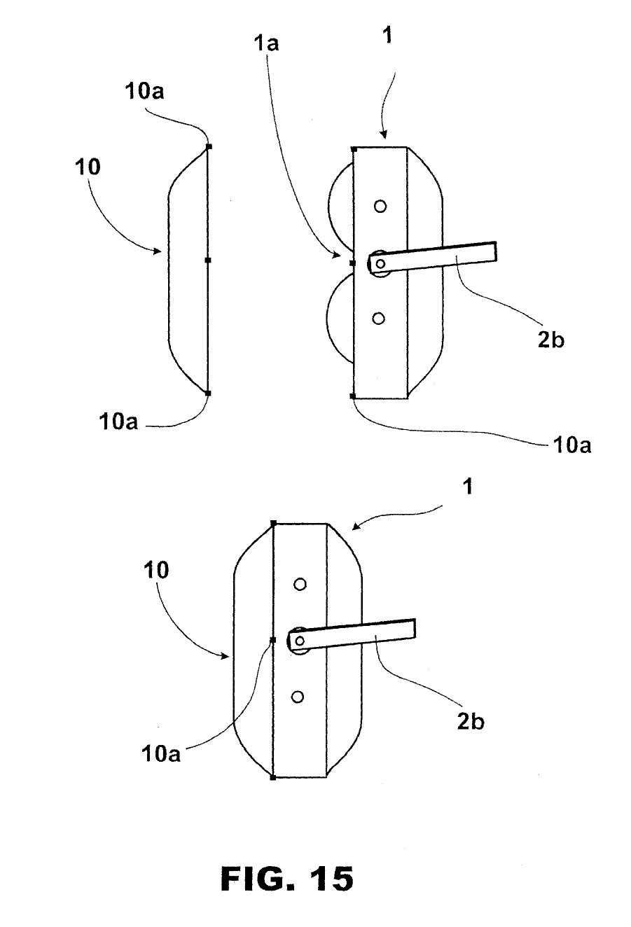

In the different figures, the same numbers and/or letters of reference indicate the same or similar parts.

### LIST OF THE ELEMENTS

(1) Main body

(1a) Open front part of the main body (1)

(1b) The main body's (1) back part closed [it includes the first (11) and the second (12) caps].

(1c) The main body's (1) lateral walls.

(1d) Container constituted by the back part (1b) and the lateral walls (1c).

(1e) Upper cavity [formed by the first cap (11)].

(1f) Lower cavity [formed by the first cover (12)].

(1g) Rotational assembling of the rollers (3).

(1h) Lower boxing wall.

(10) Anti-drying front cap.

(10a) Front closure means

(11) First cap

(12) Second cap

(13) Guide vane.

(2) Command grip

(2a) Movable connection between the grip (2) and the body (1).

(2b) The movable connection's arms.

(20) Brake.

(20a) Gear brake.

(20b) Elastic brake.

(20c) Friction brake.

(21) Friction means [Friction washer].

(22) Elastic means [String]

(23) Fixation means.

(3) Set of rollers.

(3a) First roller.

(3b) Second roller.

(4) Fluid feeding circuit.

(4a) Pipes for fluid feeding.

(4b) Means for the circuit's (4) operation.

(40) Auxiliary fluid feeding device.

(40a) The device's container (40).

(40b) Connection between the container (40a) and the feeding circuit (4).

(40c) Compressing means.

(40d) The container's (40a) cap.

(41) Outlet.

(41a) Draw-off pipe

(42) Loading container.

(5) Fluid-distribution device.

(5a) Connection with the fluid feeding pipes.

(5b) Supplying openings

(5c) Supplying mouths

(5d) Uniform distribution dispensers

(6) The distribution device's anti-drying cap (5).

(70) Fluid to be applied.

### DESCRIPTION OF THE INVENTION

For the specified purposes, the device for the application of fluid coats to surfaces, for the application of fluids such as paints, varnishes or other fluids to surfaces at any angular position, includes:

A main body (1) open in the front part (1a),

A set of rollers (3) that, rotationally mounted on said main body (1), bulge out said front part (1a),

A command grip (2),

characterized in that it comprises:

A closed back part (1b) of the main body (1) with which it constitutes a container for the excess of fluid (1d),

A fluid distribution device (5) in at least one of the rollers (3a) (3b),

In said distribution device (5), a plurality of supplying openings (5b), that have supplying mouths (5c), and uniform distribution dispensers (5d) along said rollers (3a) (3b).

Inactive closure means (6) of the above supplying openings (5b) and

A fluid feeding circuit (4) that feeds said distribution device (5).

In general terms, this invention consists of a device for the application of fluid coats to surfaces, that comprises a main body (1) that is connected to a command grip (2) by its back part closed (1b) by means of a movable connection (2a) that allows a varied angular positioning of the main body (1) and of the set of rollers (3), which, mounted rotationally on said main body's (1) lateral walls (1c) and bulging out the open front part (1a) of same (1), are fed with the fluid supplied by a distribution device (5) which is connected to a feeding circuit (4) which is in turn fed by an auxiliary feeding device (40) and may be regulated by an operation means (4b).

Specifically, this device for the application of fluid coats to surfaces is aimed at the application of paints or other viscous fluids in walls and ceilings.

This device for the application of coats comprises several parts that constitute the main body (1), a fluid distribution device (5), a fluid feeding circuit (4) and an auxiliary feeding device (40).

Said auxiliary fluid-feeding device (40) includes a compressing means (40c), a fluid container (40a) and a connection (40b) to the feeding circuit (4). In one way of performance, this device (40) comprises a container (40) that may house a fluid loading container (42), a cap (40d) of said container, compressing means (40c) that operate in said container and an outlet pipe between the inside part of said container that acts as a draw-off pipe (41a) and an outlet connection (41) that may be connected to the feeding circuit (4).

In turn, the feeding circuit (4) includes a valve or operation system (4b) in the command grip (2) and fluid feeding pipes (4a).

The fluid-feeding pipes (4a), through two connections (5a), feed a fluid distribution device (5) that is attached to the main body (1) by one of the lateral walls (1c) of same.

On the other side and in its external face lying onto the opened front part (1a), the above-mentioned distribution device (5), has supplying openings (5b), supplying mouths (5c), uniform distribution dispensers (5d) and an anti-drying cap (6).

The distribution device (5) has been prepared for the possibility of having a horizontal inclination to allow channeling the fluid within the first cap (11) when this device works in horizontal position. The inclination should be one that does not prevent the dispensers activity (5d).

The above-mentioned main body (1) is constituted by an open front part (1a), a closed back part (1b), lateral walls (1c) and a low boxing wall (1e).

The above-mentioned back part closed (1b) comprises a first cap (11) adjacent to the upper roller (3a), a second cap (12) adjacent to the lower roller (3b) and a guide vane (13) that acts as a means to channel the fluid from the first cap (11) directly on the lower roller (3b).

Said back part closed (1b) is connected to a command grip (2) through a movable connection (2a) that allows several angular positions of the handle with respect to the main body (1). In order to prevent the main body (1) to stay at rest position when hanging from the movable connection (2a) when it loses contact with the surface of work, there is a brake strong enough so as to keep the main body and the handle attached and not to obstruct said joint (2a).

In the main body's (1) lower part there is a cavity (1f) of fluid between the low boxing wall (1e) and the lateral walls (1c).

In turn, and by means of two rotational assemblages (1g) supported in said lateral walls (1c), they project by the open front part (1a) to a set of rollers (3). The rollers (3) are partially contained by the container (1d) formed between the above mentioned lateral walls (1c) and the back part closed (1b).

The possibility of using a removable anti-drying cap (10) that may close the container (1d) by the open front part (1a) in which the rollers bulge out has been planned. It has also been planned that this cap (10) has a closure means (10a) to allow its connection with the walls (1c) and the main body (1).

### Operation of the Set

The fluid inside the auxiliary deposit's (40a) container (40a) is pushed into the feeding circuit (4) by the compressing means (40c) through a connection (40b).

The feeding circuit (4) receives the fluid, and, through the operation valve (4b) allows or not the passage of fluid to the feeding pipes (4a).

In turn, the above-mentioned feeding circuits (4a) are connected to the fluid distribution device (5) through two connections (5a).

In this way, the fluid inside the distribution device (5) passes through the supplying openings (5b) that have supplying mouths (5c) in which the uniform distribution dispensers (5d) distribute the fluid in the first roller (3a) in an uniform way. The excess of fluid shall fall onto a second roller (3b) through the guide vane (13).

The guide vane (13) acts when the device is applied to a vertical wall. In this vertical position, the caps (11) (12) act as a barrier that prevents spills in the back part; those spills of the excess of fluid deposit on the cap (11) and are redirected by the guide vane (13) directly on the roller (3b). When the device works in horizontal position, the cavities (1d) (1e) formed by the caps (11) (12) acts as a bucket that retains the fluid that goes out the suppliers. In this way, the roller (3a) is fed by immersion.

The main body (1), together with the set of rollers (3), may be maneuvered by the command grip (2) and thanks to the movable connection (2a) that, with the aid of a brake, restricts the joint's motion.

In one way of performance, it has been planned the movable connection (2a) to include a gear brake (20a) that includes a set of gears, being one of them fixed and mounted to the main body and another movable and supportive of the command grip (2).

In another way of performance, the movable connection (2a) comprises an elastic brake (20b) that includes at least one end with cavities on which the elastically propelled body acts.

In another way of performance, the movable connection (2a) comprises a friction means (20c) with friction means (21) [For instance, a friction washer] in the movable connection (2a) between the main body's (1) lateral walls (1c) and the command grip's (2) arms (2b). It has been planned to include fixation means (23) and an elastic means (22) [For instance, a string].

Undoubtedly, when this invention is taken into practice, changes may be introduced in certain construction details and forms which do not imply a distinction from the fundamental principles included in the below claims:

Having described and determined the nature of this invention, and how it may be taken into practice, the following is claimed as exclusive rights and property:

What is claimed is:

1. A device for the application of fluid coats to surfaces comprising:
a main body open in a front end;
a set of rollers rotationally mounted on said main body, wherein the set of rollers project out the front end of the main body;
a command grip, wherein the command grip includes a cap for the main body forming a container of the excess of fluid;
a fluid distribution device connected to at least one of the rollers, wherein the fluid distribution device includes a plurality of supplying openings with channeling means arranged along said roller;
a closure means connected to the supplying openings, and
a fluid feeding circuit connected to the fluid distribution device.

2. The device according to claim 1, wherein the fluid distribution device includes a plurality of supplying openings that converge in guide vanes constituted by dispensers.

3. The device according to claim 2, wherein the fluid distribution device comprises a plurality of supplying openings that converge in two guide vanes constituted by dispensers.

4. The device according to claim 2, wherein the dispensers form prominent mouths oriented towards the adjacent surface of the roller.

5. The device according to claim 2, wherein the fluid distribution device includes a cap in the dispenser openings.

6. The device according to claim 2, wherein the fluid distribution device has a transversal inclination that, in the normal horizontal work position, helps the fluid to channel into the first supplying openings.

7. The device according to claim 1, wherein the cap is in a back end of the main body, opposite to the open front end in which the rollers project.

8. The device according to claim 1, wherein the cap comprises a first cap adjacent to the upper roller, a second cap adjacent to the lower roller, and a part that prolongs as guide vane to channel the fluid from said first cap towards said lower roller.

9. The device according to claim 1, wherein the closure means includes caps adjacent to the roller that act vertically as a barriers against spills and horizontally as buckets where at least one of the rollers soaks with the fluid accumulated.

10. The device according to claim 1, wherein the command grip is connected with the main body through a brake device that comprises a joint between said command grip and said main body and a brake mechanism that restricts said joint's motion.

11. The device according to claim 10, wherein the brake systems includes a set of gears, said set of gears includes a fixed gear and a movable gear, said fix gear is mounted in the main body, and said movable gear acts jointly with the command grip.

12. The device according to claim 10, wherein the brake mechanism comprises at least one end with cavities in which an elastically-propelled part acts.

13. The device according to claim 10, wherein the brake mechanism comprises friction means arranged in the joints between the main body and the command grip.

14. The device according to claim 1, wherein the fluid feeding circuit is mounted on the command grip and ends in the fluid distribution device.

15. The device according to claim 1, wherein the fluid feeding circuit comprises a means of operation by valves.

16. The device according to claim 13, wherein the valve means is mounted on the command grip.

17. The device according to claim 1, further including an auxiliary feeding device including a container housing a recipient for fluid, a cap for said container, compressing means to act upon said container, and at least one outlet pipe between said an interior part of the container and an outlet connection connected to the feeding circuit.

18. The device according to claim 1, further including a removable anti-drying cap to close the container by its open front part in which the rollers project out.
